(19) United States
(12) Patent Application Publication
(10) Pub. No.: US 2005/0053380 A1
(43) Pub. Date: Mar. 10, 2005

(54) Optical transceiver for reducing crosstalk

(76) Inventors: Sung Il Kim, Daejeon-Shi (KR); Yong Sung Eom, Daejeon-Shi (KR); Jong Deog Kim, Daejeon-Shi (KR); Kwang Seong Choi, Seoul (KR); Jong Hyun Lee, Daejeon-Shi (KR); Ho Gyeong Yun, Iksan-Shi (KR); Byung Seok Choi, Daejeon-Shi (KR); Jong Tae Moon, Iksan-Shi (KR)

Correspondence Address: JACOBSON HOLMAN PLLC, 400 SEVENTH STREET N.W., SUITE 600, WASHINGTON, DC, 20004, US

(21) Appl. No.: 10/803,988

(22) Filed: Mar. 19, 2004

(30) Foreign Application Priority Data
Sep. 6, 2003 (KR) 2003-62417

(51) Int. Cl. H04B 10/00

(52) U.S. Cl. 398/139

(57) ABSTRACT

Provided is an optical transceiver for reducing crosstalk, comprising a light signal transmitter, a photoelectric transducer having a light transmitting device that converts the electrical signal into the light signal for transmission and a light receiving device that converts a received light signal into an electrical signal, and an electronic component that is located on a PCB connected to a leadframe or inside the optical transceiver module and amplifies, modulates, and demodulates the electrical signals in receiving and transmitting, whereby it is possible to implant the crosstalk level of less than −90 dB capable of retaining the reception sensitivity to −26 dBm in the optical transceiver, by forming the dummy ground lines on the substrate to reduce the crosstalk between the light transmitting device and the receiving device mounted on the silicon substrate.

### BACKGROUND OF THE INVENTION

1. Field of the invention

The present invention relates to an optical transceiver for reducing crosstalk and, more particularly, to an optical transceiver for reducing crosstalk, which is implemented by mounting both a light transmitting device and a light receiving device on a single substrate.

2. Description of the Prior Art

Recently, new services have been realized more and more, such as multimedia high-speed Internet, video conference, IP telephony, video on demand (VOD), internet game, telecommuting, electronic commerce, distance learning and teaching, telemedicine, and etc., and transmission capacity of a backbone network has greatly increased. However, there has been little changes in the transmission capacity of a subscribe network. This means that a bottleneck may occur between the backbone network and the subscribe network in providing various multimedia services by the subscribe network. It is not easy to remove the bottleneck by using x digital subscribe line (xDSL) and cable modem for a subscribe network solution, which is most widely used now. Thus, there is a need for a passive optical network (hereinafter referred to as PON) as a new technology, which can be manufactured at low costs, has a simple network structure and high compatibility, and can deal with all of data, audio, and video services.

The PON technologies are classified into two types; one is asynchronous transfer mode (hereinafter referred to as ATM) PON and the other is Ethernet PON. The ATM PON has been developed for incorporation of IP data, video, and high-speed services such as 10/100 Mbps Ethernet, and for providing the incorporated information with low-cost and high-speed. However, the ATM PON is not applicable to the subscribe network, because it has incapacity of video transmission, an insufficiency of bandwidth, high complexity, high cost, etc. For these reasons, technologies such as high-speed Ethernet, gigabit Ethernet and so on have been developed, and thus the Ethernet PON having a bandwidth of 1.25 Gbps has been introduced.

The optical transceiver is connected to an optical fiber, and comprised of a light signal transmitting unit having a planar lightwave circuit (hereinafter referred to as PLC), a photoelectric transducer having a light transmitting device and a light receiving device, and an electronic component having a pre-amplifier and a light transmitting device driving circuit. In the case of the transceiver components being hybrid-integrated, an electrical crosstalk occurs, i.e., a high-speed signal from the light-transmitting device has an effect on the operation of the light-receiving device. The electrical crosstalk makes an operation range of the light receiving device to be limited due to a great reduction in reception sensitivity of the light receiving device, so that entire operating performance of the optical transceiver may be deteriorated. Particularly, the electrical crosstalk is seriously increased in the case of a high-speed signal. Therefore, it is required to develop the optical transceiver capable of reducing the electrical crosstalk to develop a high-speed optical transceiver such as an optical transceiver for the Ethernet PON mentioned above.

Hereinafter, an optical transceiver according to a prior art will be described with reference to FIGS. 1 and 2.

FIG. 1 is a schematic configuration diagram of an optical transceiver for reducing crosstalk, by using a technology for increasing a space between a light transmitting device and a light receiving device, and a technology for forming a central ground line between the light transmitting device and the light receiving device, according to a prior art. FIG. 2 is a schematic configuration diagram illustrating a portion of the optical transceiver shown in FIG. 1

The optical transceiver according to the prior art is composed of a light signal transmitter 1100, a photoelectric transducer 1200, a substrate 1300, a leadframe 1400, a package encapsulant 1500, and a leadframe pad 1600.

The light signal transmitter 1100 transmits a light signal received from an optical fiber 1700 to a light receiving device 1260, and transmits a light signal generated from a light transmitting device 1210 to an optical fiber 1700.

The photoelectric transducer 1200 converts a light signal into an electrical signal, and vice versa. And, the photoelectric transducer is comprised of the light transmitting device 1210 for converting the electrical signal into the light signal, a high-speed signal line 1220 for the light transmitting device, a bias line 1230 for the light transmitting device, a monitor photo detector (MPD) 1240 for monitoring optical power of the light transmitting device 1210, a signal line 1250 for the MPD, the light receiving device 1260 for converting the light signal into the electrical signal, a high-speed signal line 1270 for the light receiving device, a bias line 1280 for the light receiving device, and a central ground line 1290.

The leadframe 1400, the package encapsulant 1500, and the leadframe pad 1600 are necessary components to easily mount on a printed circuit board (PCB) when forming a module.

The optical transceiver according to the prior art prevents interference between the light transmitting device 1210 and the light receiving device 1260 by widening a physical space between the light transmitting device 1210 and the light receiving device 1260 and by forming the central ground line 1290 between the light transmitting device 1210 and the light receiving device 1260.

According to the prior art, it is possible to mount the optical transceiver on a small form factor pluggable (SFP) package as a standard module for the PON, when the operating speed reaches up to several hundred Mbps. However, when the operating speed becomes several Gbps, there is a problem that the optical transceiver cannot be mounted on the SFP package since the physical space between the light transmitting device 1210 and the light receiving device 1260 becomes increased up to several tens of millimeters. Further, the central ground line 1290 disposed between the light transmitting device 1210 and the light receiving device 1260 may be efficient only in case that it is assumed as a general dielectric since conductivity as an electrical characteristic of a silicon substrate on which the light transmitting device 1210 and the light receiving device 1260 are mounted is very low. However, there is a problem that a substrate having very high conductivity takes much expense, thereby it cannot be implemented with low costs.

### SUMMARY OF THE INVENTION

Accordingly, the present invention is contrived to solve the aforementioned problems. The present invention is directed to an optical transceiver for reducing crosstalk.

Further, the present invention is directed to an optical transceiver having a narrower physical space between a light transmitting device and a light receiving device.

Further, the present invention is directed to an optical transceiver that can be implemented on a silicon substrate having a resistivity of 10 Ohm commonly used.

Further, the present invention is directed to an optical transceiver having both of a crosstalk characteristic of −90 dB or less and a reflection characteristic of −10 dB or less so as to be suitable for an Ethernet PON for 1.25 Gbps.

One aspect of the present invention is to provide an optical transceiver, comprising: a photoelectric transducer implemented on a substrate and having a light transmitting device for converting an electrical signal into a light signal, a high-speed signal line for the light transmitting device, a bias line for the light transmitting device, a light receiving device for converting the light signal into the electrical signal, a high-speed signal line for the light receiving device, a bias line for the light receiving device, a first dummy ground line located adjacent to the high-speed signal line for the light transmitting device, and a second dummy ground line located adjacent to the high-speed signal line for the light receiving device; and a light signal transmitter connected to the photoelectric transducer, transmitting a light signal received from an optical fiber to the light receiving device, and transmitting a light signal generated from the light transmitting device to the optical fiber.

In a preferred embodiment of the present invention, the optical transceiver may further comprise a package encapsulant attached to the substrate; a leadframe pad located inside the package encapsulant; and a plurality of leadframes connected to the high-speed signal line for the light transmitting device, the bias line for the light transmitting device, the high-speed signal line for the light receiving device, the bias line for the light receiving device, the first dummy ground line, the second dummy ground line, and the leadframe pad, respectively. In addition, the photoelectric transducer further comprises a monitor photo detector (MPD) and a monitor photo detector (MPD) signal line for monitoring optical power of the light transmitting device.

Here, the substrate is composed of a silicon substrate having a silicon oxide film. The high-speed signal line for the light transmitting device is located between the bias line for the light transmitting device and the first dummy ground line, and the high-speed signal line for the light receiving device is located between the bias line for the light receiving device and the second dummy ground line.

Here, the space between the high-speed signal line for the light transmitting device and the first dummy ground line is less than or equal to the space between the high-speed signal line for the light transmitting device and the bias line for the light transmitting device, and the space between the high-speed signal line for the light receiving device and the second dummy ground line is less than or equal to the space between the high-speed signal line for the light receiving device and the bias line for the light receiving device. And, the first and the second dummy ground lines are located outside the photoelectric transducer, and the bias lines for the light transmitting device and the light receiving device are located inside the photoelectric transducer.

Meanwhile, the first dummy ground line is located between the high-speed signal line for the light transmitting device and the bias line for the light transmitting device, and the second dummy ground line is located between the high-speed signal line for the light receiving device and the bias line for the light receiving device. The light transmitting device is a laser diode and the light receiving device is a photo diode. And, the light signal transmitter is composed of a planar lightwave circuit (PLC).

### BRIEF DESCRIPTION OF THE DRAWINGS

The above and other objectives, features and advantages of the present invention will be more apparent from the following detailed description taken in conjunction with the accompanying drawings, in which:

FIG. 1 is a schematic configuration view showing an optical transceiver according to a prior art;

FIG. 2 is a schematic configuration view showing a portion of an optical transceiver according to a prior art;

FIG. 3 is a schematic configuration view showing an optical transceiver according to a preferred embodiment of the present invention;

FIG. 4 is a schematic configuration view showing a portion of the optical transceiver according to a preferred embodiment of the present invention;

FIG. 5 is a graph showing a crosstalk characteristic and a reflection characteristic of the optical transceiver according to a prior art; and

FIG. 6 is a graph showing a crosstalk characteristic and a reflection characteristic of the optical transceiver according to a preferred embodiment of the present invention.

### DETAILED DESCRIPTION OF PREFERRED EMBODIMENTS

Hereinafter, the present invention will be described with reference to the accompanying drawings. As many apparently widely different embodiments of the present invention may be made without departing from the spirit and scope thereof, it is to be understood that the invention is not limited to the below specific embodiments thereof. Embodiments of the present invention are to provide to more fully explain the present invention to those skilled in the art.

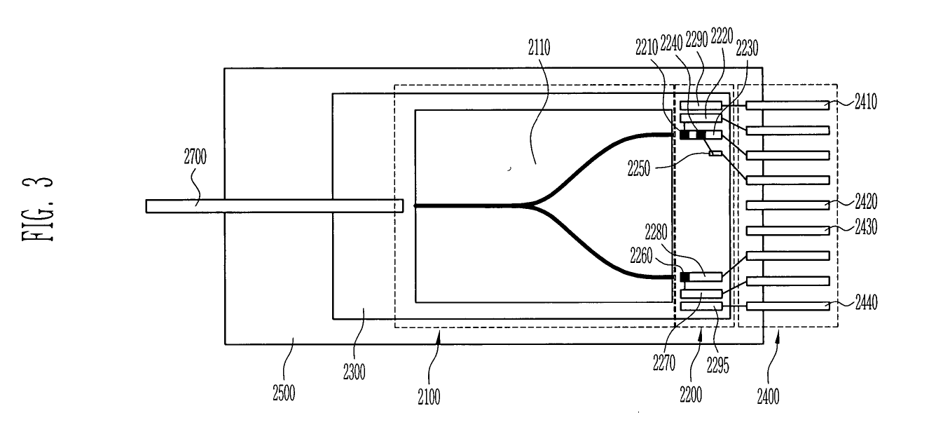

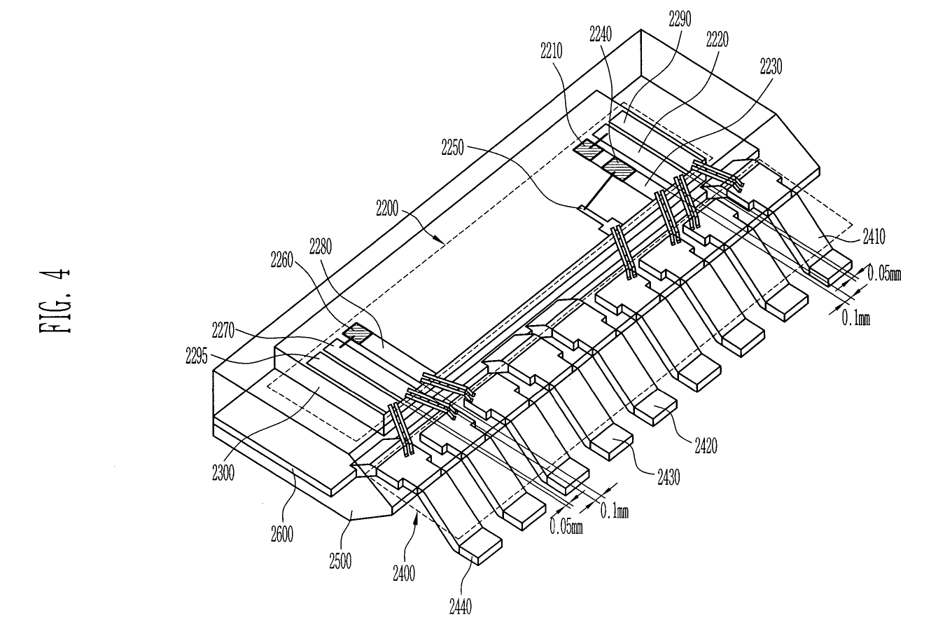

FIG. 3 is a diagram showing a schematic configuration of an optical transceiver in accordance with a preferred embodiment of the present invention. FIG. 4 is a schematic configuration view showing a portion of the optical transceiver shown in FIG. 3.

The optical transceiver shown in FIGS. 3 and 4 is comprised of a light signal transmitter 2100, a photoelectric transducer 2200, a substrate 2300, a leadframe 2400, a package encapsulant 2500, and a leadframe pad 2600. The optical transceiver may include other electronic components (not shown).

The light signal transmitter 2100 is adapted to transmit a light signal received from an optical fiber 2700 into a light receiving device 2260, and transmit a light signal generated from a light transmitting device 2210 into the optical fiber 2700. The light signal transmitter 2100 has a planar lightwave circuit (PLC) 2110, for example. Two ends of the Y-branch shaped PLC 2110 are connected to the light transmitting device 2210 and the light receiving device 2260, respectively.

The photoelectric transducer 2200 is adapted to convert a light signal into an electrical signal, and vice versa. The photoelectric transducer 2200 is comprised of the light transmitting device 2210 for converting the electrical signal into the light signal, a high-speed signal line 2220 for the light transmitting device, a bias line 2230 for the light transmitting device, a monitor photo detector (MPD) 2240 for monitoring optical power of the light transmitting device 2210, a signal line 2250 for the MPD, the light receiving device 2260 for converting the light signal into the electrical signal, a high-speed signal line 2270 for the light receiving device, a bias line 2280 for the light receiving device, a first dummy ground line 2290, and a second dummy ground line 2295.

The light transmitting device 2210 and the light receiving device 2260 are connected to both ends of the PLC 2110, respectively. The light transmitting device 2210 converts an electrical signal inputted from an external driving circuit (not shown) into a light signal having a wavelength bandwidth of, e.g., 1.3 micrometers (μm), and then transmits the light signal to the other optical transceiver (not shown) through the PLC 2110 and the optical fiber 2700. The light receiving device 2260 converts an light signal having a wavelength bandwidth of e.g., 1.5 μm, inputted from the other optical transceiver through the PLC 2110 and the optical fiber 2700 into an electrical signal, and then transmits the electrical signal to a pre-amplifier (not shown) mounted on the outside. The light transmitting device 2210 may be a laser diode, and the light receiving device 2260 may be a photo diode. The driving circuit and the pre-amplifier may be comprised in an electric circuit (not shown).

The first dummy ground line 2290 and the second dummy ground line 2295 are located adjacent to the high-speed signal line 2220 for the light transmitting device and the high-speed signal line 2270 for the light receiving device, respectively. When the space between the first dummy ground line 2290 and the high-speed signal line 2220 for the light transmitting device is less than or equal to the space between the bias line 2230 for the light transmitting device and the high-speed signal line 2220 for the light transmitting device, and the space between the second dummy ground line 2295 and the high-speed signal line 2270 for the light receiving device is less than or equal to the space between the bias line 2280 for the light receiving device and the high-speed signal line 2270 for the light receiving device, noise components of the high-speed signal line 2220 for the light transmitting device and the high-speed signal line 2270 for the light receiving device are primarily coupling to each of the first dummy ground line 2290 and the second dummy ground line 2295, resulting in reducing the electrical crosstalk. For example, as shown in FIG. 4, the space between the high-speed signal line 2220 for the light transmitting device and the first dummy ground line 2290 can be designed to be 0.5 times less than the space between the bias line 2230 for the light transmitting device and the high-speed signal line 2220 for the light transmitting device, and the space between the high-speed signal line 2270 for the light receiving device and the second dummy ground line 2295 can be designed to be 0.5 times less than the space between the bias line 2280 for the light receiving device and the high-speed signal line 2270 for the light receiving device.

As shown in the figures, the bias line 2230 for the light transmitting device and the first dummy ground line 2290 can be located at both sides of the high-speed signal line 2220 for the light transmitting device, respectively, and the bias line 2280 for the light receiving device and the second dummy ground line 2295 can be located at both sides of the high-speed signal line 2270 for the light receiving device, respectively. In this case, as shown in the figures, the bias line 2230 for the light transmitting device and the bias line 2280 for the light receiving device can be located inside the photoelectric transducer 2200, and the first dummy ground line 2290 and the second dummy ground line 2295 can be located outside the photoelectric transducer 2200. Here, the space between the first dummy ground line 2290 and the high-speed signal line 2220 for the light transmitting device must be less than or equal to the space between the bias line 2230 for the light transmitting device and the high-speed signal line 2220 for the light transmitting device. Also, the space between the second dummy ground line 2295 and the high-speed signal line 2270 for the light receiving device must be less than or equal to the space between the bias line 2280 for the light receiving device and the high-speed signal line 2270 for the light receiving device.

Meanwhile, the first dummy ground line 2290 can be located between the high-speed signal line 2220 for the light transmitting device and the bias line 2230 for the light transmitting device, the second dummy ground line 2295 can be located between the high-speed signal line 2270 for the light receiving device and the bias line 2280 for the light receiving device.

A silicon substrate having a silicon oxide film with a thickness of several μm on the substrate may be desirably used as the substrate 2300.

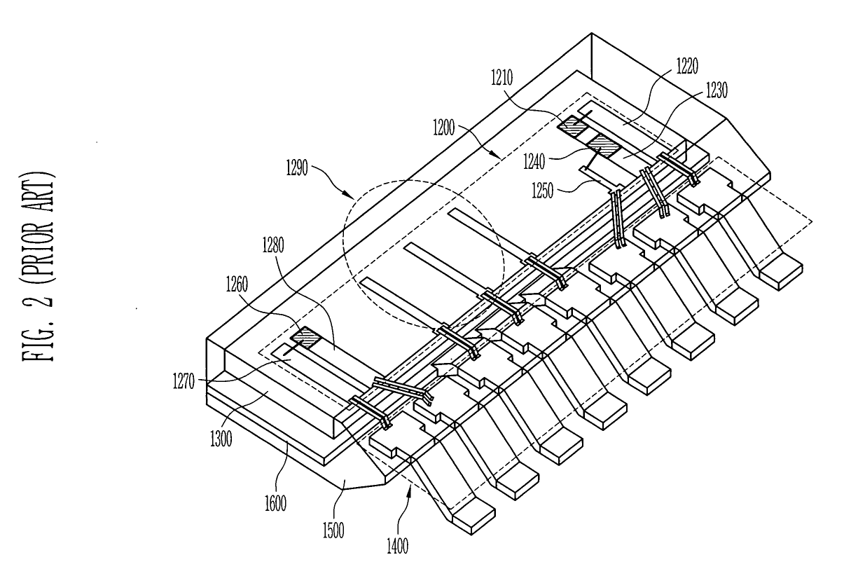

The leadframe 2400, the package encapsulant 2500, and the leadframe pad 2600 are necessary components to easily mount on the PCB when forming a module. Leadframes corresponding to reference numerals 2410, 2420, 2430 and 2440 of the leadframe 2400 are connected to the ground. Unlike FIG. 2, the leadframes for reference corresponding to reference numerals 2420 and 2430 are not connected to additional central grounds on the substrate, and they are connected to the leadframe 2600, and used to support it mechanically and reduce parasitic components in only the leadframe 2400. The leadframe 2400 may be a lead frame of a family of Alloy42, for example.

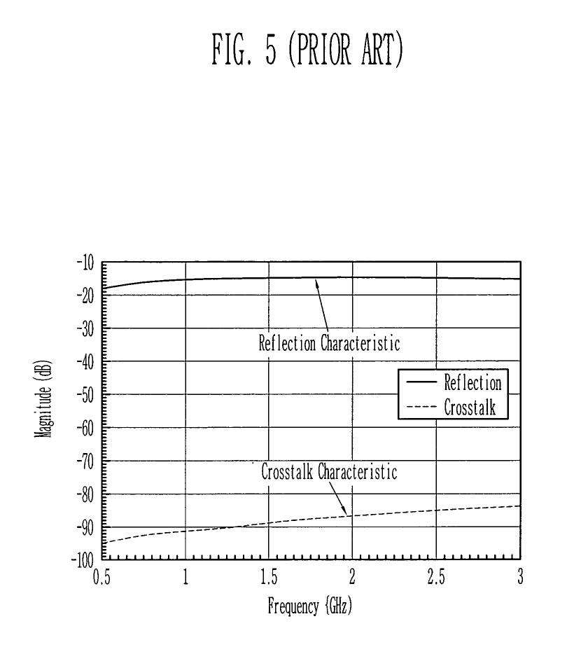

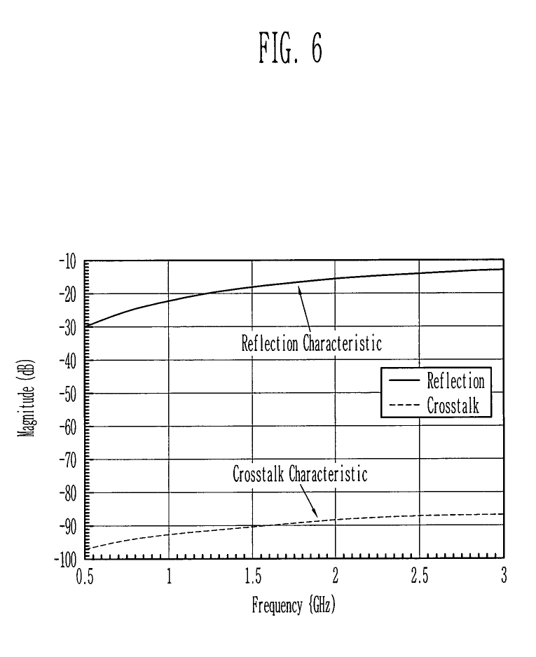

Hereinafter, a preferred embodiment of the present invention will be compared with the prior art in reference to FIGS. 5 and 6.

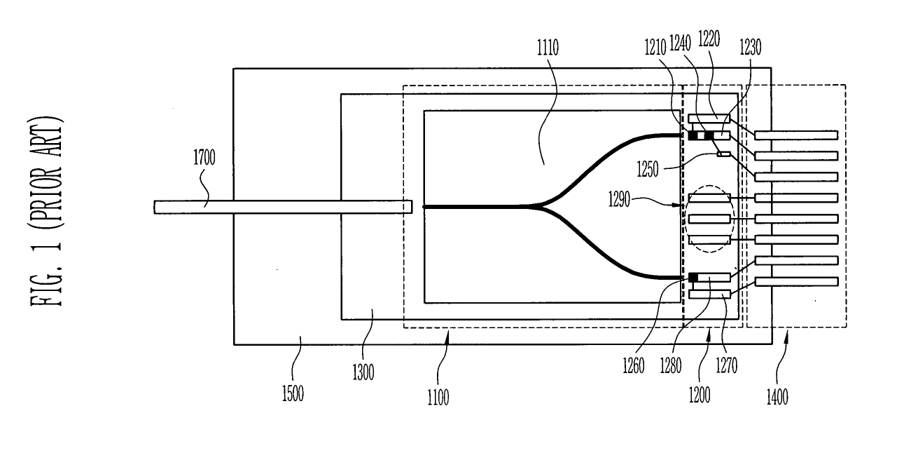

FIG. 5 illustrates a crosstalk characteristic and a reflection characteristic of the optical transceiver manufactured in accordance with the prior art shown in FIGS. 1 and 2. In this optical transceiver, the space between the light transmitting device and the light receiving device is 8.09 mm, and the entire width of the optical transceiver is 10.5 mm. From FIG. 5, it can be noted that the crosstalk characteristic in the frequency of 1.25 GHz is less than −90 dB so as to satisfy the module receiving sensitivity of −26 dBm, and the reflection characteristic in the frequency of 1.25 GHz is less than −10 dB so as to connect to a 50 Ohm system.

FIG. 6 illustrates a crosstalk characteristic and a reflection characteristic of the optical transceiver manufactured by the embodiment of the present invention shown in FIGS. 3 and 4. In this optical transceiver, the space between the light transmitting device and the light receiving device is 4.7 mm, and the entire width of the optical transceiver is 8.4 mm. From FIG. 6, it can be appreciated that the optical transceiver according to the present invention is applicable to the Ethernet PON optical transceiver for 1.25 Gbps, since the crosstalk characteristic and the reflection characteristic in the frequency of 1.25 GHz are less than −90 dB and −10 dB, respectively, as similar with FIG. 5

As described above, in view of the crosstalk characteristics and the reflection characteristics in the frequency of 1.25 GHz in accordance with the prior art and the present invention, the optical transceiver manufactured by the present invention can obtain reduction of about 40% in the space between the light transmitting device and the light receiving device, and reduction of about 20% in the width of the optical transceiver, as compared with the optical transceiver manufactured by the prior art.

The optical transceiver according to the present invention has advantages that can remove the electrical crosstalk with holding the physical space between the light transmitting device and the light receiving device close to each other, by forming the dummy ground lines to be adjacent to the light transmitting device and the light receiving device.

In addition, the optical transceiver according to the present invention can make use of a silicon substrate having a resistivity of 10 Ohm commonly used in the technical field. Also, it may has the advantage that the module can reduce about 20% of its size by using this substrate, as compared with the prior art, even in the case of manufacturing the optical transceiver for an Ethernet PON having the crosstalk characteristic of less than −90 dB and the reflection characteristic of less than −10 dB, respectively in the frequency of 1.25 GHz.

Furthermore, the optical transceiver according to the present invention has advantages that it is adaptable for production in mass quantities without changing any production lines, since it can be easily implemented and there are no additional components required.

Although a preferred embodiment of the present invention has been described for illustrative purposes, those skilled in the art will appreciate that various modifications, additions and substitutions are possible, without departing from the scope and spirit of the invention as disclosed in the accompanying claims.

The present application contains subject matter related to korean patent application No. 2003-62417, filed in the Korean Patent Office on Sep. 6, 2003, the entire contents of which being incorporated herein by reference.

1. An optical transceiver, comprising:
a photoelectric transducer implemented on a substrate and having a light transmitting device for converting an electrical signal into a light signal, a high-speed signal line for the light transmitting device, a bias line for the light transmitting device, a light receiving device for converting the light signal into the electrical signal, a high-speed signal line for the light receiving device, a bias line for the light receiving device, a first dummy ground line located adjacent to the high-speed signal line for the light transmitting device, and a second dummy ground line located adjacent to the high-speed signal line for the light receiving device; and
a light signal transmitter connected to the photoelectric transducer, transmitting a light signal received from an optical fiber to the light receiving device, and transmitting a light signal generated from the light transmitting device to the optical fiber.

2. The optical transceiver of claim 1, wherein the substrate is composed of a silicon substrate having a silicon oxide film.

3. The optical transceiver of claim 1, wherein the first dummy ground line is located between the high-speed signal line for the light transmitting device and the bias line for the light transmitting device; and
the second dummy ground line is located between the high-speed signal line for the light receiving device and the bias line for the light receiving device.

4. The optical transceiver of claim 1, wherein the light transmitting device is a laser diode and the light receiving device is a photo diode.

5. The optical transceiver of claim 1, wherein the light signal transmitter is composed of a planar lightwave circuit (PLC).

6. The optical transceiver of claim 1, wherein the high-speed signal line for the light transmitting device is located between the bias line for the light transmitting device and the first dummy ground line; and
the high-speed signal line for the light receiving device is located between the bias line for the light receiving device and the second dummy ground line.

7. The optical transceiver of claim 6, wherein the space between the high-speed signal line for the light transmitting device and the first dummy ground line is less than or equal to the space between the high-speed signal line for the light transmitting device and the bias line for the light transmitting device; and
the space between the high-speed signal line for the light receiving device and the second dummy ground line is less than or equal to the space between the high-speed signal line for the light receiving device and the bias line for the light receiving device.

8. The optical transceiver of claim 6, wherein the first and the second dummy ground lines are located outside the photoelectric transducer; and
the bias lines for the light transmitting device and the light receiving device are located inside the photoelectric transducer.

9. The optical transceiver of claim 1, wherein the photoelectric transducer further comprises a monitor photo detector (MPD) and a monitor photo detector (MPD) signal line for monitoring optical power of the light transmitting device.

10. The optical transceiver of claim 9, wherein the first dummy ground line is located between the high-speed signal line for the light transmitting device and the bias line for the light transmitting device; and
the second dummy ground line is located between the high-speed signal line for the light receiving device and the bias line for the light receiving device.

11. The optical transceiver of claim 9, wherein the light transmitting device is a laser diode and the light receiving device is a photo diode.

12. The optical transceiver of claim 9, wherein the light signal transmitter is composed of a planar lightwave circuit (PLC).

13. The optical transceiver of claim 9, wherein the high-speed signal line for the light transmitting device is located between the bias line for the light transmitting device and the first dummy ground line; and
the high-speed signal line for the light receiving device is located between the bias line for the light receiving device and the second dummy ground line.

14. The optical transceiver of claim 13, wherein the space between the high-speed signal line for the light transmitting device and the first dummy ground line is less than or equal to the space between the high-speed signal line for the light transmitting device and the bias line for the light transmitting device; and
the space between the high-speed signal line for the light receiving device and the second dummy ground line is less than or equal to the space between the high-speed signal line for the light receiving device and the bias line for the light receiving device.

15. The optical transceiver of claim 13, wherein the first and the second dummy ground lines are located outside the photoelectric transducer; and
the bias lines for the light transmitting device and the light receiving device are located inside the photoelectric transducer.

16. The optical transceiver of claim 1, further comprising:
a package encapsulant attached to the substrate;
a leadframe pad located inside the package encapsulant; and
a plurality of leadframes connected to the high-speed signal line for the light transmitting device, the bias line for the light transmitting device, the high-speed signal line for the light receiving device, the bias line for the light receiving device, the first dummy ground line, the second dummy ground line, and the leadframe pad, respectively.

17. The optical transceiver of claim 16, wherein the first dummy ground line is located between the high-speed signal line for the light transmitting device and the bias line for the light transmitting device; and
the second dummy ground line is located between the high-speed signal line for the light receiving device and the bias line for the light receiving device.

18. The optical transceiver of claim 16, wherein the light transmitting device is a laser diode and the light receiving device is a photo diode.

19. The optical transceiver of claim 16, wherein the light signal transmitter is composed of a planar lightwave circuit (PLC).

20. The optical transceiver of claim 16, wherein the high-speed signal line for the light transmitting device is located between the bias line for the light transmitting device and the first dummy ground line; and
the high-speed signal line for the light receiving device is located between the bias line for the light receiving device and the second dummy ground line.
